(19) United States
(12) Patent Application Publication
(10) Pub. No.: US 2012/0003375 A1
(43) Pub. Date: Jan. 5, 2012

(54) Cassava Products

(76) Inventors: Athula Ekanayake, Cincinnati, OH (US); Paul Ralph Bunke, Cincinnati, OH (US)

(21) Appl. No.: 12/826,741

(22) Filed: Jun. 30, 2010

(51) Int. Cl. A21D 13/04; A21D 13/00

(52) U.S. Cl. 426/550; 426/549

(57) ABSTRACT

Products that include cassava flour. The products can be dry blends, doughs, and fabricated snack products. The cassava flour can have a total cyanide content of less than 10 mg HCN equivalent/kg, can have a peak RVA viscosity ranging from about 700 cP to about 1200 cP, can have a final RVA viscosity ranging from about 200 cP to about 1100 cP, and can be formed from a crushed cassava root having a cyanide content of at least 50 mg HCN equivalent/kg.

### FIELD

The present disclosure relates to cassava products. Specifically, cassava flour having high fiber and a low concentration of cyanogenic compounds is described. The related cassava products can be produced from of high fiber cassava flour from bitter-type cassava roots having a high concentration of cyanogenic glucosides.

### BACKGROUND

Cassava (Manihot esculenta) is an important subsistence crop in many tropical areas including, for example, Asia, Africa and Latin America, with a number of end uses for the edible storage roots. The roots are rich in carbohydrate, i.e., starch, which serves as an important raw material for the production of starch and some chemicals. The root is a widely used source of food and industrial starch. The main cassava product is tapioca starch. The edible roots are also employed as an important staple food in many regions.

Various varieties of cassava exist. For example, cassava may be categorized by the content of toxic cyanogenic compounds present in the fresh root. The cyanogenic compounds in fresh roots naturally occur in certain cyanogenic glucosides, in particular linamarin and lotaustralin. Based on the cyanogenic contents in the roots, cassava may be classified in to three classes including low toxic (or sweet type), medium toxic, and high toxic root, with a cyanide content of less than 50, 50 to 100, and greater than 100 mg HCN equivalents per kilogram fresh root weight, respectively. Cassava root with 50 mg HCN equivalents/kg fresh root weight may be called bitter-type cassava root. The contents of cyanogenic compounds in the cassava root may vary, depending on cassava variety, harvest time, environmental conditions, and farm practices. The low cyanide or sweet cassava is typically used for direct consumption as a staple food, while the bitter type is mostly processed to chips, pellets, and starch for industrial applications. It is critical that during processing of bitter-type cassava-based products that the cyanogenic compounds be removed so that the residual content in the finished products are not greater than safe levels. Various processes, such as cooking, boiling, drying, and frying have been developed to successfully detoxify cassava to produce products safe for use as food and feed products.

Cassava flour is a cassava-based product derived from fresh roots being used in many dietary applications, for example, as a substitute for other commercial flours in snack, bakery and pasta products. Cassava flour is currently not a commercial product and is only produced in small amounts to satisfy domestic market demands. Methods of producing cassava flour using simple equipment and primarily at a household-scale have been developed. For example, the fresh roots may be cut, sliced, or pounded into small pieces and then sun-dried and subsequently milled into a flour. The actual processing practice may vary depending on geographical origin of the cassava, the flour quality, and the end application.

For the purpose of food applications, the cyanide content of the cassava flour should contain less than 10 mg HCN equivalent/kg dried weight in order to comply with food safety standards according to WHO/FAO Codes Alimentarius. Thus, sweet cassava root is typically used for making cassava flour. Production of low-cyanide content cassava flour (less than 10 mg HCN equiv/kg dried weight) from bitter-type cassava root requires appropriate processing to ensure effective removal of the cyanogenic compounds. The methods recited herein provide a method for the industrial production of low-cyanide cassava flour from bitter-type cassava root raw materials. The resulting cassava flour may have high content of crude fiber, thus providing additional dietary benefits. Use of cassava flour produced by the processes described herein instead of cassava starch may provide multiple benefits including: providing a good source of additional dietary fiber; a potential of lower cost starch source due to the increase in flour yield compared to the lower starch yields from cassava root; and lower energy use for dough mixing because of lower peak viscosity during starch cooking.

### SUMMARY

In one embodiment, the present disclosure provides a cassava flour formed from a bitter-type cassava root comprising less than 10 mg HCN equivalent/kg and a crude fiber content ranging from about 1% to about 7% on a dry weight basis. In specific embodiments, the cassava flour formed from a bitter-type cassava root may be produced by any of the processes described herein.

Other embodiments provide for a dry blend, wherein the dry blend comprises from about 1% to about 100% of the cassava flour formed from a bitter-type cassava root comprising less than 10 mg HCN equivalent/kg and a crude fiber content ranging from about 1% to about 7% on a dry weight basis.

Other embodiments provide for a fabricated snack product wherein the fabricated snack product comprises a dry blend, wherein the dry blend comprises from about 1% to about 100% of the cassava flour formed from a bitter-type cassava root comprising less than 10 mg HCN equivalent/kg and a crude fiber content ranging from about 1% to about 7% on a dry weight basis.

### BRIEF DESCRIPTION OF THE DRAWINGS

The various embodiments of the present disclosure may be better understood when read in conjunction with the following figures.

FIGS. 1a, 1b, and 1c are scanning electron micrographs of isolated tapioca starch, wet processed cassava flour and dry processed cassava flour, respectively.

FIG. 2 illustrates the viscosity of tapioca starch (alone and with various fiber additives) compared to wet and dry processed cassava flour.

### DETAILED DESCRIPTION

### Definitions

As used herein, the term “bitter-type cassava root” means cassava root having greater than 50 mg HCN equivalent/kg fresh weight. The term “sweet-type cassava root” means cassava root having less than 50 mg HCN equivalents/kg fresh weight.

As used herein, the term “cyanide content” means the total cyanide (bound cyanogen, non-glucosidic cyanogen, and free cyanide) present in the cassava product, as measured in mg HCN equivalents/kg weight.

As used herein, the units “mg HCN equivalents/kg weight” is a measure of the total cyanide content of the cassava material. The value is typically determined using the enzymatic method according to O'Brien, et al., “Improved enzymatic assay for cyanogen in fresh and processed cassava,” J. Sci. Food Agri. 1991, 56, 277-289.

As used herein, the term “bitter-type” when used in reference to a cassava root means the root has at least 50 mg HCN equivalents/kg weight and in certain cases greater than 100 mg HCN equivalents/kg weight.

As used herein, the term “low-cyanide” when used in reference to a cassava flour means a cassava flour having less than 10 mg HCN equivalents/kg dry product.

As used herein, the term “high fiber” when used in reference to a cassava flour means a flour having a crude fiber content of at least about 1% on a dry weight basis.

As used herein, the term “industrial scale” means a production scale of at least 1 ton/day.

By the term “dry blend” it is meant herein the dry raw material mixed together prior to processing of the materials so mixed.

As used herein “dry processed cassava flour” means cassava roots subjected to washing to remove soil and other non-root components, rasped, pressed to remove moisture and dried to produce a cassava flour.

As used herein “wet processed cassava flour” means cassava roots subjected to washing to remove soil and other non-root components, rasped, pressed to remove moisture, re-wetted with an amount of water, pressed a second time to remove added water and dried to produce a cassava flour.

As used herein, the term “comprising” means various components conjointly employed in the preparation of the composition or methods of the present disclosure. Accordingly, the terms “consisting essentially of” and “consisting of” are embodied in the term “comprising”.

As used herein, the articles including “the”, “a” and “an” when used in a claim or in the specification, are understood to mean one or more of what is claimed or described.

As used herein, the terms “include”, “includes” and “including” are meant to be non-limiting.

As used herein, the term “plurality” means more than one.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Process for Producing a Cassava Flour

The present disclosure provides a process for producing a low cyanide, high fiber cassava flour. In specific embodiments, the process may provide for the production of the low cyanide, high fiber cassava flour using a bitter-type cassava root feed stock. According to certain embodiments, the process may produce the cassava flour using a minimum of water during one or more wash processes. The cassava flour produced by the various embodiments described herein may have a cyanide content suitable for human or animal consumption, for example, a cyanide content of less than 10 mg HCN equivalent/kg on a dry weight basis. Further the cassava flour may have high levels of crude dietary fiber.

Cassava root may come in either sweet-type or bitter-type cassava root. Bitter-type root may have cyanide levels, either in the form of glycosidic cyanogens, non-glycosidic cyanogens, or free cyanide (such as HCN or other cyanide compounds) that make products produced form it unsuitable for human consumption without specific and expensive processing. Thus, production methods are necessary to reduce the cyanide levels in the cassava product to acceptable levels. Many common methods are performed on a small, household scale and may not be suitable for use on an industrial scale, for example, due to the use of large quantities of wash water. In addition, multiple washes with large amounts of water may impact certain characteristics of the resulting cassava flour, for example, the crude fiber content of the cassava flour and/or the viscosity of the cassava flour. Thus, cyanide removal from cassava is not possible without serious economic considerations. According to the present disclosure, bitter-type cassava root may be processed in to cassava flour having acceptable cyanide content and high levels of crude dietary fiber.

The process recited herein utilizes various embodiments endogenous enzymes in the root or other cassava plant tissue to release cyanide from its glycosides (linamarin and lotaustralin) or other bound form to acetone cyanohydrin which then spontaneously dissociates to volatile HCN under the process pH. Use of specific reaction time, temperature, and pH conditions maximize the release of cyanide from the root. With the cyanide levels reduced by enzymatic means, multiple washings with large amounts of water are not necessary to remove the cyanide, which also results in a higher fiber content. The cassava flour should be in its native or inherent form and will provide certain advantages, including, for example, a reduction in peak viscosity of up to 45% when the flour is cooked compared to the isolated starch (making it easier to cook and requiring less energy when mixing as a dough) and the addition of dietary fiber to the starch without a perceptible change in its sensory properties. The resulting cassava flour has low levels of cyanide and high levels of crude fiber and may be incorporated into food products and/or used as a replacement for other types of flour in dry blends used in the production of snack products.

According to one embodiment, the present disclosure provides a process for producing a low cyanide, high fiber cassava flour. The process may comprise providing a mash comprising crushed cassava root, adjusting a pH of the mash, incubating the mash at the appropriate temperature for at least 30 minutes, pressing the mash to remove excess water and provide a cassava cake, and processing the cassava cake to provide a low cyanide cassava flour. The cassava flour made by this process may have a crude fiber content ranging fro about 1% to about 7% on a dry weight basis. In specific embodiments, the low cyanide cassava flour may have a total cyanide content of less than about 10 mg HCN equivalents/kg of dry flour, in other embodiments the cassava flour may have a total cyanide content of less than about 5 mg HCN equivalents/kg dry weight and in specific embodiments the cassava flour may have a total cyanide content of less than about 2 mg HCN equivalents/kg dry weight.

The crushed cassava root in the mash may have a cyanide content of at least 50 mg HCN equivalents/kg weight, and in certain embodiments the crushed cassava root may have a cyanide content of at least 100 mg HCN equivalents/kg. In certain embodiments, providing the mash comprising crushed cassava root may comprise peeling at least a portion of a bitter-type cassava root having a cyanide content of at least 50 mg HCN equivalents/kg weight, cleaning the peeled cassava root, and crushing and/or rasping the cleaned cassava root to provide a mash comprising crushed and/or rasped cassava root. In specific embodiments, the bitter-type cassava root may have a cyanide content of at least 100 mg HCN equivalents/kg. Crushing and/or rasping the cassava root may be done by any method commonly used in the art.

The pH of the mash may be adjusted to a pH in which the enzymatic reaction of the cyanogenic glucosides occurs. For example, according to one embodiment, the pH of the mash may be adjusted to a pH ranging from about 5.0 to about 7.5. According to another embodiment, the pH of the mash may be adjusted to a pH ranging from about 6.0 to about 7.0. In certain embodiments, the pH of the cassava root mash, prior to adjusting the pH, may range from about 5.8 to about 6.2. In such a case, it may not be necessary to adjust the pH of the cassava root mash. Alternatively, if the pH of the mash does not fall within the recited values, the pH of the mash may be adjusted, for example by adding an acid or base, such as an edible acid or base to the mash.

In various embodiments, incubating the mash may be performed at a temperature ranging from about 30° C. to about 60° C., and in other embodiments the mash may be incubated at a temperature ranging from about 55° C. to about 60° C. The mash may be incubated for an appropriate time, for example, a time greater than 30 minutes. In certain embodiments, the mash may be incubated for a time ranging from about 30 minutes to about 2 hours.

In specific embodiments, incubating the mash may comprise incubating the mash in the present of a β-glucosidase enzyme. For example, the mash may be incubated in the presence of a linamarase enzyme. Linamarase is a β-glucosidase which catalyzes the hydrolysis of the cyanogenic glucoside (such as linamarin or lotaustralin) present in the bitter-type cassava material. The β-glucosidase, such as linamarase, may catalyze the hydrolysis reaction to release the carbohydrate and a cyanohydrin (α-hydroxynitrile). The cyanohydrin may then rapidly degrade to provide a ketone and hydrogen cyanide (HCN) under the pH and temperature conditions of the enzymatic hydrolysis reaction. Alternatively, an enzyme, such as a hydroxynitrile lyase, or other chemical reactant may be utilized to hydrolyze the cyanohydrin. Thus, for example, linamarin may hydrolyze, catalyzed by linamarase, to provide glucose and acetone cyanohydrin, which may then rapidly hydrolyze to provide acetone and HCN. In specific embodiments, the β-glucosidase, such as linamarase, may be endogenous. In other embodiments, the β-glucosidase, such as linamarase, may be exogenous and added to the mash prior to incubation. Other exogenous β-glucosidases may also be suitable for the incubation step provided that they catalyze the hydrolysis of the cyanogenic glucoside. For example, in one embodiment, the other exogenous glucosidase enzyme may be an enzyme developed by genetic manipulation of certain microorganisms, such as, for example, those described in U.S. Pat. No. 5,116,744. In another embodiment, the exogenous glucosidase may be a partially purified cold water extract of cassava leaf, containing large molecular weight materials which includes the glucosidase enzyme.

After the mash has been incubated, as described herein, the mash may be pressed or filtered to remove excess water and water soluble compounds. According to these embodiments, pressing or filtering the mash may remove excess water and provide a cassava cake, which may then be processed into a low cyanide cassava flour. In specific embodiments, the pressing the mash may be followed by one or more washing steps. As described herein, to produce a low cyanide cassava flour that is also high in fiber, such as crude fiber, washing the mash may be done using a minimum of water. Without intending to be bound by any theory, it is believed that using only small amounts of water in the one or more washing steps limits the amount of fiber that is removed from the cassava cake material, resulting in a higher fiber cassava flour product. Further, by minimizing the amount of water used in the one or more washing steps, the industrial production of the low-cyanide cassava flour becomes more economically feasible and less damaging to the environment (i.e., no disposal of or recycling of large quantities of wash water). Thus, according to one embodiment, the processes described herein may further comprise washing the cake with a first amount of water weighing less than 4.0 times the weight of the crushed cassava root in the mash and pressing the cake to provide a washed cassava cake. In other embodiments, the first amount of water may be less than 3.0 times the weight of the crushed cassava root, in other embodiments less than 2.5 times the weight of the crushed cassava root or even less than 2.0 times the weight of the crushed cassava root. According to other embodiments, the processes described herein may further comprising washing the cake with a second amount of water weighing less than 4.0 times the weight of the crushed cassava root and repressing the cake to provide the washed cassava cake. In other embodiments, the second amount of water may be less than 3.0 times the weight of the crushed cassava root, in other embodiments less than 2.5 times the weight of the crushed cassava root or even less than 2.0 times the weight of the crushed cassava root. According to specific embodiments, the first water wash amount and the second water wash amount may each use an amount of water ranging from about 1.7 to about 1.8 times the weight of the crushed cassava root. In still other embodiments, a third or further washings may be performed, wherein the washes are similar to the first and second washings. According to certain embodiments, the processes described herein may use less than 25 m³ of water per 1000 kg of low cyanide cassava flour product produced by the process.

After the cassava cake is formed, the cake may be further processed to provide the low cyanide cassava flour. The processed flour may have a fiber (crude or dietary) content ranging from about 1% to about 7% on a dry weight basis. In other embodiment, the cassava flour may have a fiber content ranging from about 2% to about 6%, or even about 3% to about 5% on a dry weight basis. In certain embodiments, processing the cassava cake may comprise drying the washed cassava cake to provide a dried cassava cake and processing the dry cassava cake to provide the low cyanide cassava flour. For example, in one embodiment, drying the washed cassava cake may be at a temperature ranging from about 100° C. to about 200° C., or in other embodiments, the drying temperature may be at least 140° C., for example, from about 140° C. to about 160° C. Drying the cassava cake may be performed in any suitable dryer, for example, a flash dryer or oven dryer. In specific embodiments, the higher drying temperatures may result in volatization of the non-glucosidic cyanides. For example, residual acetone cyanohydrin and hydrogen cyanide may be vaporized by heat during the drying process at elevated temperatures (at temperature greater than or equal to 82° C. and 26° C., respectively). The recited temperatures during drying may result in lowering of non-glucosidic cyanide concentrations, consequently lowering the total cyanide content of the cassava flour product. After drying, the dry cassava cake may be processed into the low cyanide cassava flour by various methods, for example, by grinding, milling, and/or sieving to provide a fine powder. For example, the dried flour may be milled and sieved through 100 mesh and then packed for shipping.

According to the various embodiments described herein, the low cyanide, high fiber cassava flour produced by the processes herein may have a desired viscosity. The viscosities of the cassava flours were determined using a Rapid Viscosity Analyzer (RVA), as disclosed herein. Pastes of the flour were prepared and analyzed for various parameters including peak viscosity and final viscosity. According to certain embodiments, the cassava flour produced by the processes herein may have a peak RVA viscosity ranging from about 700 centipoise (cP) to about 1200 cP, or in other embodiments from about 900 cP to about 1100 cP. In other embodiments, the cassava flour produced by the processes herein may have a final RVA viscosity ranging from about 200 cP to about 1100 cP, or in other embodiments from about 400 cP to about 900 cP.

In one specific embodiment, the process for producing a low cyanide cassava flour may comprise peeling at least a portion of bitter-type cassava roots having a cyanide content of at least 50 mg HCN equivalent/kg; cleaning the cassava roots to provide a cleaned cassava root; crushing and/or rasping the cleaned cassava root to provide a cassava mach; incubating the cassava mash at a temperature ranging from about 30° C. to about 60° C. for a time ranging from about 30 minutes to about two hours; pressing the mash to remove excess water and provide a cassava cake; washing the cassava cake with a first amount of water weighing from about 1 to about 2 times the weight of the bitter-type cassava root; pressing the cassava cake to remove substantially all of the first amount of water; repeating the washing and pressing steps with a second amount of water weighing from about 1 to about 2 times the weight of the bitter-type cassava roots to provide a wash cassava cake; drying the washed cassava cake; and processing the dry cassava cake to provide a low cyanide cassava flour having a crude fiber content ranging from about 1% to about 7%. As used herein, the term “substantially all” when used in reference to the removal of water by pressing means removal of at least 70% by volume of the water in the cake. Other processes in which this process is modified according to one or more modifications described herein are also within the scope of this process.

The various embodiments of the processes for producing a low-cyanide cassava flour described herein are suitable for use in the industrial production of the cassava flour on an industrial level, such as a production level of at least 1 ton of cassava flour per day in one production line. In certain embodiments, the process may be used in the industrial production of at least 3 tons of cassava flour per day for one production line. According to one embodiment, the processes described herein may provide a yield or conversion ratio of at least about 1 kg of cassava flour from about 2.5 kg of fresh cassava roots, such as bitter-type cassava roots.

The present disclosure also provides for a cassava flour formed from a bitter-type cassava root. The cassava flour may be formed by any of the processes described herein. In addition, the present disclosure provides for a cassava flour formed from a bitter-type cassava root, wherein the cassava flour comprises less than about 10 mg of HCN equivalent/kg dry weight and a crude fiber content ranging from about 1% to about 7% on a dry weight basis. In other embodiments, the cassava flour may comprise less than about 5 mg of HCN equivalent/kg dry weight and a crude fiber content ranging from about 1% to about 7% on a dry weight basis; and in still other embodiments the cassava flour comprises less than about 2 mg of HCN equivalent/kg dry weight and a crude fiber content ranging from about 1% to about 7% on a dry weight basis.

Although the use of the cassava flour will be described primarily in terms of a fabricated snack product, it should be readily apparent to one skilled in the art that the cassava flour produced by the process described herein can be used in the production of any suitable food products. For instance, the cassava flour can be used to produce food products such as extruded products, breads, sauces, crackers, fried snacks, fruit and vegetable snacks, baked or dried snacks, coatings for fried foods, baby foods, dog foods, dog biscuits and any other suitable food product. The production of the fabricated snack product is set forth in detail below.

The present disclosure also provides for dry blends and edible compositions formed from the low cyanide, high fiber cassava flour made by the processes described herein. For example, in one embodiment, the present disclosure provides a dry blend suitable for making a fabricated snack product, such as, but not limited to, a chip, a fabricated snack crisp, a crisp, a potato crisp, a cracker, a bar, and a bread. Other examples of fabricated snack products that may be made using the cassava flour described herein are disclosed in the following publications: U.S. Pat. No. 6,066,353; United States Publication No. 2003/0113431; United States Publication No. 2005/0053715; United States Publication No. 2006/0286271; United States Publication No. 2008/0187642; United States Publication No. 2008/0213432; United States Publication No. 2009/0004356; and United States Publication No. 2009/0202700. The dry blend may comprise from about 1% to about 100% by weight of the cassava flour described herein. In other embodiments, the present disclosure provides a dry blend for making a fabricated snack product, wherein at least a portion of at least another starch or flour product is replaced with the cassava flour of the present disclosure. For example, in certain embodiments, the cassava flour may replace at least a portion of at least one of wheat flour, rice flour, corn flour, quinoa flour, teff flour, amaranth flour, rice starch, potato starch, cassava starch, sago starch, and corn starch that may be present in a dry blend formulation. In specific embodiments, the cassava flour may replace all of one or more of the other flours or starches in a dry blend formulation.

According to other embodiments, the present disclosure provides for a dough made from the dry blends comprising the cassava flour described herein.

### Dough Formulation

The various embodiments of the doughs of the present disclosure may comprise a dry blend, as described herein, and added water. In certain embodiments, the doughs may comprise from about 50% to about 85% dry blend and from about 15% to about 50% added water. The doughs can further comprise optional ingredients.

### Dry Blend

Specific embodiments of the doughs may comprise from about 50% to about 85% dry blend, or even from about 60% to about 75% dry blend.

The dry blend may comprise the cassava flour produced herein. In certain embodiments, the dry blends comprise from about 2% to about 100%, in other embodiments from about 20% to about 85%, and in still other embodiments from about 40% to about 75% cassava flour with the balance being other ingredients, such as other starch or flour materials. Suitable sources of other starch or flour material include tapioca, oat, wheat, rye, barley, corn, masa, rice, cassava starch, non-masa corn, peanut, and dehydrated potato products (e.g., dehydrated potato flakes, potato granules, potato flanules, mashed potato materials, and dried potato products). These other starch materials can be blended to make snacks of different compositions, textures, and flavors. Furthermore, the balance of the dry blend can comprise one or more components including but not limited to, protein sources, fiber, minerals, vitamins, colorants, flavors, fruits, vegetables, seeds, herbs, spices

In one embodiment the dry blend may have a Peak Viscosity ranging from about 70 RVU to about 120 RVU, in another embodiment from about 75 RVU to about 100 RVU and in still another embodiment from about 80 RVU to about 90 RVU. In another embodiment herein the dry blend may have a Final Viscosity ranging from about 90 RVU to about 150 RVU, in another embodiment from about 100 RVU to about 125 RVU, and in still another embodiment from about 100 RVU to about 115 RVU.

### Added Water

Specific embodiments of the dough compositions of the present disclosure may comprise from about 15% to about 50% added water, in another embodiment from about 20% to about 40%, and in still another embodiment from about 20% to about 32% added water. If optional ingredients, such as maltodextrin or corn syrup solids, juices, concentrates, are added as a solution or syrup, the water in the syrup or solution is included as added water. The amount of added water also includes any water used to dissolve or disperse ingredients.

### Optional Ingredients

Any suitable optional ingredient may be added to the doughs of the present disclosure. Such optional ingredients can include, but are not limited to, gum, reducing sugar, emulsifier, and mixtures thereof. Optional ingredients may be included at a level ranging from about 0% to about 50%, and in another embodiment in 0% to about 40%, by weight in the dough. Examples of suitable gums can be found in U.S. Pat. No. 6,558,730, issued May 6, 2003, to Gizaw et al.

Optionally, reducing sugar can be added to the dough. While the reducing sugar content can be dependent upon that of the potatoes that were employed to prepare the dehydrated potato product, the amount of reducing sugar in the fabricated snack products can be controlled by adding suitable amounts of a reducing sugar such as maltose, lactose, dextrose, or mixtures thereof to the dough. The dry blend of the present disclosure may contain from 0% to about 20%, in another embodiment from 0% to about 10%, and in still another embodiment from 0% to about 7.5%, by weight, maltodextrin.

An ingredient that can optionally be added to the dough to aid in its processability is emulsifier. In one embodiment, the emulsifier is added to the dough composition prior to sheeting the dough. The emulsifier can be dissolved in a fat or in a polyol fatty acid polyester such as Olean™. Suitable emulsifiers include lecithin, mono- and diglycerides, diacetyl tartaric acid esters and propylene glycol mono- and diesters and polyglycerol esters. Polyglycerol emulsifiers, such as monoesters of hexaglycerols, can be used. Specific embodiments of monoglycerides are sold under the trade names of Dimodan available form DANISCO®, New Century, Kansas and DMG 70, available from Archer Daniels Midlands Company, Decatur, Ill.

### Dough Preparation

The doughs of the present disclosure may be prepared by any suitable method for forming sheetable doughs. Typically, a loose, dry dough is prepared by thoroughly mixing together the ingredients using conventional mixers. In one embodiment, a pre-blend of the wet ingredients and a pre-blend of the dry ingredients are prepared; the wet pre-blend and the dry pre-blend are then mixed together to form the dough. In one embodiment, HOBART® mixers may be used for batch operations and in another embodiment TURBULIZER® mixers may be used for continuous mixing operations. Alternatively, extruders can be used to mix the dough and to form sheets or shaped pieces.

### Sheeting

Once prepared, the dough may then be formed into a relatively flat, thin sheet. Any method suitable for forming such sheets from starch-based doughs can be used. For example, the sheet can be rolled out between two counter rotating cylindrical rollers to obtain a uniform, relatively thin sheet of dough material. Any conventional sheeting, milling and gauging equipment can be used. According to various embodiments, the mill rolls may be heated to from about 90° F. (32° C.) to about 135° F. (57° C.). In a specific embodiment, the mill rolls are kept at two different temperatures, with the front roller being hotter than the back roller. The dough can also be formed into a sheet by extrusion.

Doughs of the present disclosure may be formed into a sheet having a thickness ranging from about 0.015 to about 0.10 inches (from about 0.038 to about 0.25 cm), and in another embodiment to a thickness ranging from about 0.019 to about 0.05 inches (from about 0.048 to about 0.127 cm), and in still another embodiment from about 0.02 inches to about 0.03 inches (0.051 to 0.076 cm).

The dough sheet is then formed into snack pieces of a predetermined size and shape. The snack pieces can be formed using any suitable stamping or cutting equipment. The snack pieces can be formed into a variety of shapes. For example, the snack pieces can be in the shape of ovals, squares, circles, a bowtie, a star wheel, or a pin wheel. The pieces can be scored to make rippled chips as described by Dawes et al. in PCT Application No. PCT/US95/07610, published Jan. 25, 1996 as WO 96/01572.

### Cooking

After the snack pieces are formed, they are cooked until crisp to form fabricated snack products. The snack pieces can be fried, for example, in a fat composition comprising digestible fat, non-digestible fat, or mixtures thereof. For best results, clean frying oil should be used. In one embodiment, the free fatty acid content of the oil may be maintained at less than about 1%, and in another embodiment less than about 0.3%, in order to reduce the oil oxidation rate. Any other method of cooking or drying the dough, such as high temperature extrusion, baking, microwave heating, or combination is also acceptable.

In a specific embodiment of the present disclosure, the frying oil may have less than about 30% saturated fat, in another embodiment less than about 25%, and in still another embodiment less than about 20%. This type of oil improves the lubricity of the finished fabricated snack products such that the finished fabricated snack products have an enhanced flavor display. The flavor profile of these oils also may enhance the flavor profile of topically seasoned products because of the oils' lower melting point. Examples of such oils include sunflower oil containing medium to high levels of oleic acid.

In another embodiment of the present disclosure, the snack pieces are fried in a blend of non-digestible fat and digestible fat. In one embodiment, the blend comprises from about 20% to about 90% non-digestible fat and from about 10% to about 80% digestible fat, in another embodiment from about 50% to about 90% non-digestible fat and from about 10% to about 50% digestible fat, and in still another embodiment from about 70% to about 85% non-digestible fat and from about 15% to about 30% digestible fat. Other ingredients known in the art can also be added to the edible fats and oils, including antioxidants such as TBHQ, tocopherols, ascorbic acid, chelating agents such as citric acid, and anti-foaming agents such as dimethylpolysiloxane.

In specific embodiments, the snack pieces may be fried at temperatures of from about 275° F. (135° C.) to about 420° F. (215° C.), in another embodiment from about 300° F. (149° C.) to about 410° F. (210° C.), and in still another embodiment from about 350° F. (177° C.) to about 400° F. (204° C.) for a time sufficient to form a product having about 6% or less moisture, in another embodiment from about 0.5% to about 4%, and in still another embodiment from about 1% to about 3% moisture. The exact frying time is controlled by the temperature of the frying fat and the starting water content of the dough, which can be easily determined by one skilled in the art.

According to certain embodiments, the snack pieces are fried in oil using a continuous frying method and are constrained during frying. This constrained frying method and apparatus is described in U.S. Pat. No. 3,626,466 issued Dec. 7, 1971 to Liepa. The shaped, constrained snack pieces are passed through the frying medium until they are fried to a crisp state with a final moisture content of from about 0.5% to about 4%, and in another embodiment from about 1% to about 2.5%.

Any other method of frying, such as continuous frying or batch frying of the snack pieces in a non-constrained mode, is also acceptable. For example, the snack pieces can be immersed in the frying fat on a moving belt or basket. Likewise, frying can occur in a semi-constrained process. For example, the fabricated snack pieces can be held between two belts while being fried in oil.

Oils with characteristic flavor or highly unsaturated oils can be sprayed, tumbled or otherwise applied onto the fabricated snack products after frying. In certain embodiments, triglyceride oils and non-digestible fats are used as a carrier to disperse flavors and are added topically to the fabricated snack products. These include, but are not limited to, butter flavored oils, natural or artificial flavored oils, herb oils, and oils with potato, garlic, or onion flavors added. This allows the introduction of a variety of flavors without having the flavor undergo browning reactions during the frying. This method can be used to introduce oils which would ordinarily undergo polymerization or oxidation during the heating necessary to fry the snacks.

While various specific embodiments have been described in detail herein, the present disclosure is intended to cover various different combinations of the disclosed embodiments and is not limited to those specific embodiments described herein. The various embodiments of the present disclosure may be better understood when read in conjunction with the following representative examples. The following representative examples are included for purposes of illustration and not limitation.

### EXAMPLES

### Example 1

Fresh cassava roots were washed to get rid of soil and peeled. The peeled roots were rasped to give a root pulp. The pH of the root pulp was checked to ensure that it was between 5.0-7.5. Root pulp was incubated at room temperature, 40° C., 45° C., 50° C., 55° C. and 60° C. for 2 hours. After the incubation step, the samples were pressed and the press cake dried in an oven set at 55° C. for 24 hours. Table 1 displays the total cyanide content of the resulting cassava flours.

TABLE 1
Cyanide content of cassava flour

| | Total cyanide | Total cyanide in dried |
|---|---|---|
| Incubation | in pressed cake | flour (mg/kg) |
| temperature (° C.) | (mg/kg) dry wt. | dry wt. |
| Room temp. (~30° C.) | 93.14 | 2.54 |
| 40° C. | 77.12 | 2.30 |
| 45° C. | 75.66 | 1.84 |
| 50° C. | 75.79 | 2.30 |
| 55° C. | 66.02 | 2.18 |
| 60° C. | 65.24 | 1.57 |

The fiber content in all these samples were 5.0-5.5% on a dry weight basis. It is apparent from this data that an incubation at slightly elevated temperature of the rasped cassava root containing the fiber material allows the endogenous glucosidase to act on the cyanogen glucoside precursors releasing the acetone cyanohydrin. On heating the cassava flour to dry it the acetone cyanohydrin autolyses to yield the volatile hydrocyanic acid and the less volatile acetone which are both released on drying the cassava flour resulting in a cassava flour with <2 ppm total cyanide in several of the treatments given above.

### Example 2

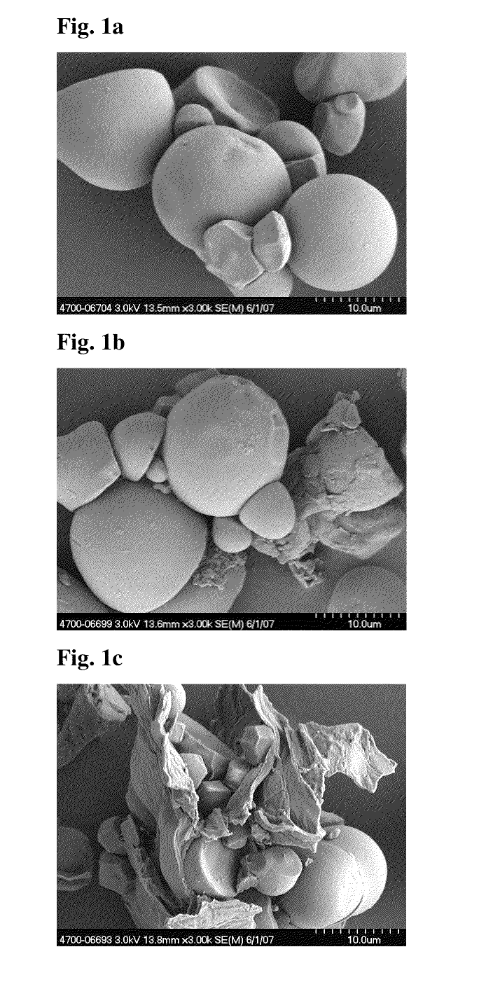

Scanning electron micrographs of the dry processed and wet processed cassava flour particles vs. isolated tapioca starch were taken and shows clearly the agglomeration of the starch particles within the flour with non starchy fibrous material as an intrinsic component of the cassava flours according to the present disclosure, compared to tapioca starch, which displays no fibrous material. FIG. 1a shows typical tapioca of cassava starch granules and no other material other than the starch. FIG. 1b illustrates wet processed cassava flour particles and shows non-starchy (fiber) materials adhering to the starch granules. FIG. 1c shows dry processed cassava flour particles and shows large amounts of non-starchy (fiber) materials adhering to the starch granules.

### Example 3

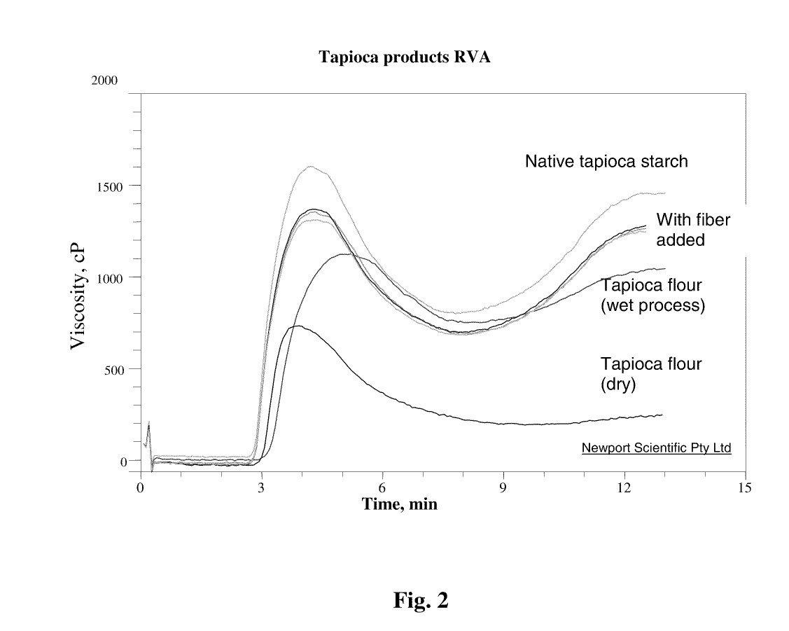

Tapioca or cassava based starches and their mixtures with added food fiber were compared with cassava flours in terms of their viscosity development properties during cooking. The following samples were subjected to RVA measurements. Tapioca starch, 12.1% moisture; wet processed cassava flour 9.1% moisture; dry processed cassava flour 6.1% moisture; tapioca starch with 5% VITACEL® (commercially available from J. Rettenmaier & Sohne GmbH+Co., Rosenberg, Germany), 11.725% moisture; tapioca starch with 5% sugar cane fiber, 11.674% moisture; tapioca starch with 5% oat fiber, 11.762% moisture. FIG. 2 plots the viscosity measurement against mixing time. Values for peak viscosity and final viscosity of each of the samples is presented in Table 2.

TABLE 2
Viscosity of tapioca starch blends compared to cassava flour

| Sample | Peak viscosity (cP) | Final viscosity (cP) |
|---|---|---|
| Tapioca starch | 1603 | 1457 |
| Tapioca starch + 5% VITACEL ® | 1356 | 1274 |
| Tapioca starch + 5% sugar cane | 1343 | 1292 |
| fiber | | |
| Tapioca starch + 5% oat fiber | 1369 | 1283 |
| Wet process cassava flour | 1125 | 1045 |
| Dry process cassava flour | 733 | 245 |

These results demonstrate that adding various types of fiber to tapioca starch does not significantly influence its viscosity behavior, except for the dilution effect. In contrast, with the cassava flours, having the fiber as an intrinsic part of the flour causes profound changes in the viscosity during cooking. This is possibly due to the interruption of starch gel that forms when pure starch gelatinizes on cooking. Fiber is of a different chemical composition than starch and is not compatible with the gelled starch thus causing a barrier to extending swelled starch complexes.

### RVA Method Using the Rapid Visco Analyzer

The rheological properties of the dry ingredients, flour blends, and finished products as disclosed herein can be measured using the Rapid Visco Analyzer (RVA) model RVA-4. The RVA was originally developed to rapidly measure α-amylase activity in sprouted wheat. This viscometer characterizes the starch quality during heating and cooling while stirring the starch sample. The Rapid Visco Analyzer (RVA) can also be used herein to directly measure the viscous properties of the starches and flours. The tool requires about 2 to 4 g of sample and about 25 grams of water.

Sample weights and the water added should be corrected for the sample moisture content to give a constant dry weight. The moisture basis normally used is 14%, and correction tables are available from Newport Scientific. The correction formulae for 14% moisture basis are:

M2=(100−14)×M1/(100−W1)

W2=25.0+(M1−M2)

where

M1=sample mass and is about 3.0 g

M2=corrected sample mass

W1=actual moisture content of the sample (% as is)

The water and sample mixture is measured while going through a pre-defined profile of mixing, measuring, heating, and cooling, as set-up using Standard Profile (1) of the instrument. This test provides dough viscosity information that translates into flour quality.

The key parameters used to characterize the present invention are pasting temperature, peak viscosity, peak viscosity time, and final viscosity.

Dry Ingredients and Flour Blend:

(1) Determine moisture (M) of sample from air oven.

(2) Calculate sample weight (S) and water weight (W).

(3) Place sample and water into canister.

(4) Place canister into RVA tower and run the Standard Profile (1).

The Standarad Profile (1) is described as follows:

| Time | Temp. (° C.) | Rotation speed (rpm) |
|---|---|---|
| 00:00:00 | 50 | 960 |
| 00:00:10 | 50 | 160 |
| 00:01:00 | 50 | 160 |
| 00:04:45 | 95 | 160 |
| 00:07:15 | 95 | 160 |
| 00:11:00 | 50 | 160 |
| 00:13:00 | 50 | 0 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present disclosure. To the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising a low cyanide cassava flour and wherein the cassava flour has a crude fiber content ranging from about 1% to about 7% on a dry weight basis.

2. The composition of claim 1 and wherein the cassava flour has a total cyanide content of less than 10 mg HCN equivalent/kg.

3. The composition of claim 1 and wherein the cassava flour has a peak RVA viscosity ranging from about 700 cP to about 1200 cP.

4. The composition of claim 1 and wherein the cassava flour has a final RVA viscosity ranging from about 200 cP to about 1100 cP.

5. The composition of claim 1 and wherein the cassava flour is formed from a crushed cassava root having a cyanide content of at least 50 mg HCN equivalent/kg.

6. The composition of claim 1 and wherein the cassava flour has a total cyanide content of less than 10 mg HCN equivalent/kg, has a peak RVA viscosity ranging from about 700 cP to about 1200 cP, has a final RVA viscosity ranging from about 200 cP to about 1100 cP, and is formed from a crushed cassava root having a cyanide content of at least 50 mg HCN equivalent/kg.

7. A composition comprising a dry blend, and wherein the dry blend comprises from about 1% to about 100% cassava flour, and wherein the cassava flour has a crude fiber content ranging from about 1% to about 7% on a dry weight basis.

8. The composition of claim 7 and wherein the cassava flour has a total cyanide content of less than 10 mg HCN equivalent/kg.

9. The composition of claim 7 and wherein the cassava flour has a total cyanide content of less than 10 mg HCN equivalent/kg, has a peak RVA viscosity ranging from about 700 cP to about 1200 cP, has a final RVA viscosity ranging from about 200 cP to about 1100 cP, and is formed from a crushed cassava root having a cyanide content of at least 50 mg HCN equivalent/kg.

10. A composition comprising a dough and wherein the dough comprises the dry blend of claim 7.

11. A composition comprising a dough and wherein the dough comprises the dry blend of claim 8.

12. A composition comprising a dough and wherein the dough comprises the dry blend of claim 9.

13. A fabricated snack product comprising a dry blend comprising from about 1% to about 100% cassava flour comprising a crude fiber content ranging from about 1% to about 7% on a dry weight basis.

14. The fabricated snack product of claim 13 and wherein the cassava flour has a total cyanide content of less than 10 mg HCN equivalent/kg.

15. The fabricated snack chip of claim 13 and wherein the cassava flour has a total cyanide content of less than 10 mg HCN equivalent/kg, has a peak RVA viscosity ranging from about 700 cP to about 1200 cP, has a final RVA viscosity ranging from about 200 cP to about 1100 cP, and is formed from a crushed cassava root having a cyanide content of at least 50 mg HCN equivalent/kg.

16. The fabricated snack product of claim 13 and further comprising at least one of wheat flour, rice flour, corn flour, quinoa flour, teff flour, amaranth flour, rice starch, potato starch, cassava starch, sago starch, and corn starch.
